(19) United States
(12) Patent Application Publication
(10) Pub. No.: US 2007/0273967 A1
(43) Pub. Date: Nov. 29, 2007

(54) Visual Communication Panel And Method For Manufacturing It

(75) Inventor: Leo Albert Julia Gypen, Zonhoven (BE)

Correspondence Address: BACON & THOMAS, PLLC, 625 SLATERS LANE, FOURTH FLOOR, ALEXANDRIA, VA, 22314, US

(73) Assignee: POLYVISION NAAMLOZE VENNOOTSCHAP, 300 GENK BELGIUM (BE)

(21) Appl. No.: 11/597,560

(22) PCT Filed: May 24, 2005
(86) PCT No.: PCT/BE05/00083

§ 371 Date: Nov. 27, 2006

(30) Foreign Application Priority Data
May 27, 2004 (BE) 2004/0262

(51) Int. Cl. G03B 21/56

(52) U.S. Cl. 359/460; 427/123

(57) ABSTRACT

Improved visual communication panel provided with a visual side (3) and a back side (4) and which mainly consists of a support (2) onto which is provided at least on the visual side (3) an enamelled metal (5), characterised in that the support (2) is provided on at least one of the above-mentioned order to prevent deformations.

The present invention concerns an improved visual communication panel, more particularly a visual communication panel of the type which mainly consists of a support or core which is provided at least on the visual side of the communication panel with a coating in the form of a layer of enamelled metal, more particularly a thin metal layer which is provided on at least one side with at least one upper layer of enamel or glaze.

Such visual communication panels may be used, depending on the nature and qualities of the enamel upper layer, as a board upon which can be written with a stylus or with chalk, as a projection screen for slide shows or film showings, as an interactive communication panel for video conferences or the like respectively, whereby the movements of a pen or a virtual pen on the panel are digitally registered and are represented “on line” on a screen, for example on the other side of the conference line or the like.

A known problem is that such visual communication panels often warp or have corrugations.

These corrugations are caused as, during the hot and cold rolling of steel, uneven deformations can be created which lead among others to long centres and/or long sides. In the case where an enamel or glaze upper layer is provided on such a plate, whereby temperatures of some 800° C. are reached or whereby, in other words, the plate is brought above the eutectic transformation temperature, additional corrugations may be created as a result of stored internal tensions. Such corrugations may be expressed as a convex plate, long centres or long sides or other irregular deformations.

In order to prevent such corrugations, the panel must be provided, and that is why also the back side of such a known visual communication panel is usually provided with a coating, either or not with a coating of a different nature on the visual side, which is to prevent the panel from warping.

The most customary coatings that are provided on the back side are made of enamelled metal, galvanized steel, aluminized steel, lacquered steel, aluminium, melamine or other synthetic materials, foil reinforced with glass fibre, paper, cardboard, cork or the like.

Such back coatings are quite expensive, however, and they are characterised by uniformly divided mechanical qualities, such as for example rigidity and/or tensile force.

The present invention aims to remedy the above-mentioned and other disadvantages by providing a coating which can be provided on the visual side as well as on the back side of a visual communication panel and which moreover can exert an appropriate local tensile force, depending of the position of the panel, in order to prevent any warping.

To this end, the invention concerns an improved visual communication panel, provided with a visual side and a back side and which mainly consists of a support provided with an enamelled metal at least on the visual side, whereby the support is provided with wires on at least one of the above-mentioned sides, in order to prevent any deformations.

The advantage which is thus obtained is that wires can be selected such and can be provided to such an extent that they can efficiently avoid the problem of imminent deformations.

Thus can be avoided that heavy and expensive full plates are to be provided.

In this manner, improved visual communication panels are obtained which are not only lighter, but also cheaper, or which can be made at least flatter for the same weight or price.

The invention also concerns a method for manufacturing an improved visual communication panel according to the invention, which mainly consists in providing a support which is provided with a coating of enamelled metal on at least one side, whereby the support is provided with wires on at least one side.

The wires are preferably provided in a continuous manner on the support.

This makes it possible to manufacture visual communication panels according to a simpler and less expensive production process.

The advantage of a continuous supply of wires is that this processing can be implemented in a continuous production process in this manner.

In order to better explain the characteristics of the invention, the following preferred embodiments of an improved visual communication panel according to the invention are given as an example only with reference to the accompanying drawings, in which:

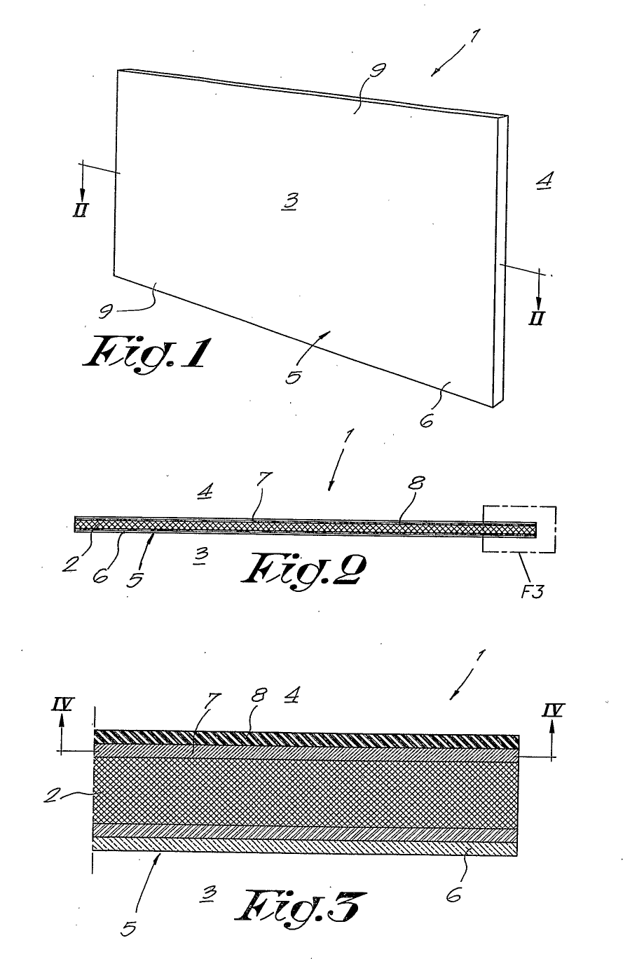

FIG. 1 schematically represents an improved visual communication panel according to the invention in perspective;

FIG. 2 is a section according to line II-II in FIG. 1;

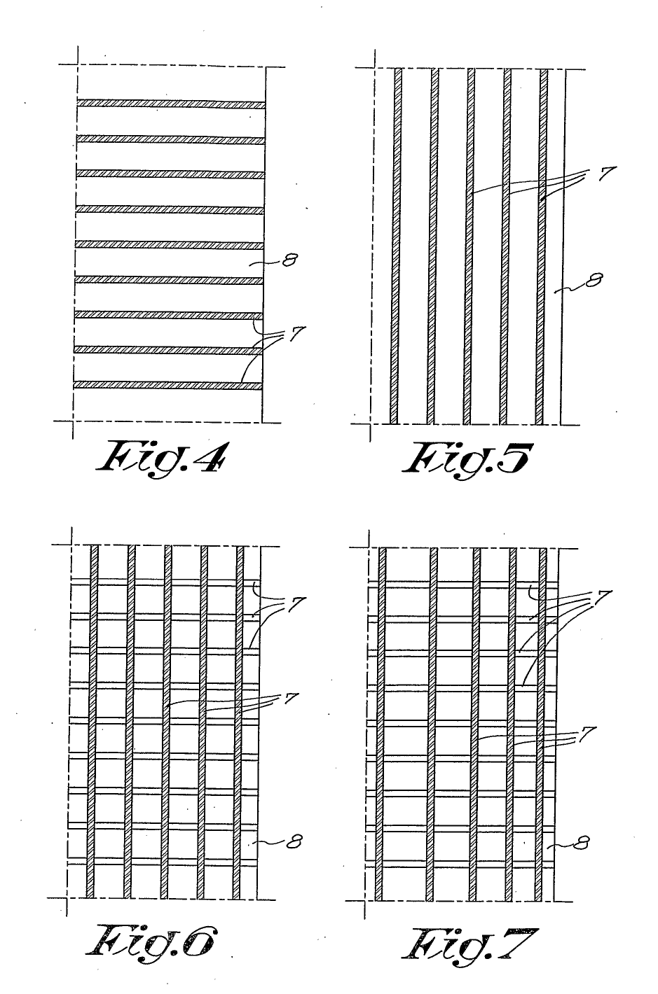

FIG. 3 represents the part indicated by F3 in FIG. 2 to a larger scale;

FIGS. 4 to 7 represent a section according to line IV-IV in FIG. 3 to a smaller scale, but for different embodiments;

FIG. 8 schematically represents a device which can be applied with the method according to the invention.

The improved visual communication panel 1, as represented in FIGS. 1 to 4, mainly consists of a support 2 provided with a visual side 3 and a back side 4, whereby the visual side 3 is provided with a metal plate 5 with an enamel layer 6, and whereby the back side 4 is provided with wires 7 onto which is provided a back coating 8.

The support 2 is made here of a filled polypropylene synthetic foil formed of a thermoplastic honeycomb structure, as described in Belgian patent application No. 2003/0263, onto which, on the visual side 3 thereof, the enamelled metal plate 5 is provided, and the wires 7 and the back coating 8 are provided on the back side 4 thereof.

The metal plate 5 with the enamel layer 6 is made for example of one or several thin metal layers onto which an enamelled first layer may be provided, but at least an enamelled upper layer is provided which, as is known, is obtained by melting an enamel layer applied on the metal layer as a liquid dispersion or in powder form, which is melted to a temperature above 500° C.

Depending of the type of application that is aimed at, coating layers may be applied with an adapted enamel upper layer. Thus, coating layers are known that can be written on with a stylus or which have the properties of a blackboard or which, by adding special pigments to the enamel, are suitable as a base for projections or the like.

The wires 7 are here, as represented in FIG. 4, all parallel to each other and parallel to two opposite side edges of the communication panel 1, for example in line with the side edges 9 of the support 2 which is continuously supplied during the production process.

The wires 7 are for example made as steel wires with a round cross section having a diameter which is equal to 1 mm.

The back coating 8 in this case consists of polypropylene foil.

The effect of the wires and the working of an improved communication panel 1 according to the invention is simple and as follows.

It is known that a rolled metal plate 5. is subject to internal tensions and consequently often has corrugations.

While enamelling such a metal plate 5, internal tensions are moreover released, as a result of which deformations will be even stronger, which has the detrimental result that it is not obvious to obtain a flat visual communication panel 1.

The wires 7 which are provided on the back side 4 of the support 2 in this embodiment prevent the panel 1 from deforming due to the released tensions in the metal plate 5.

FIG. 5 represents another preferred wire arrangement, whereby the wires are also arranged parallel to each other and at equal distances from each other, but parallel to the two other opposite sides of the communication panel 1, for example diagonally to the side edges 9 of the support 2 which is continuously supplied during the production process.

Such an orientation of the wires 7 can be considered if the panels have corrugations in that direction.

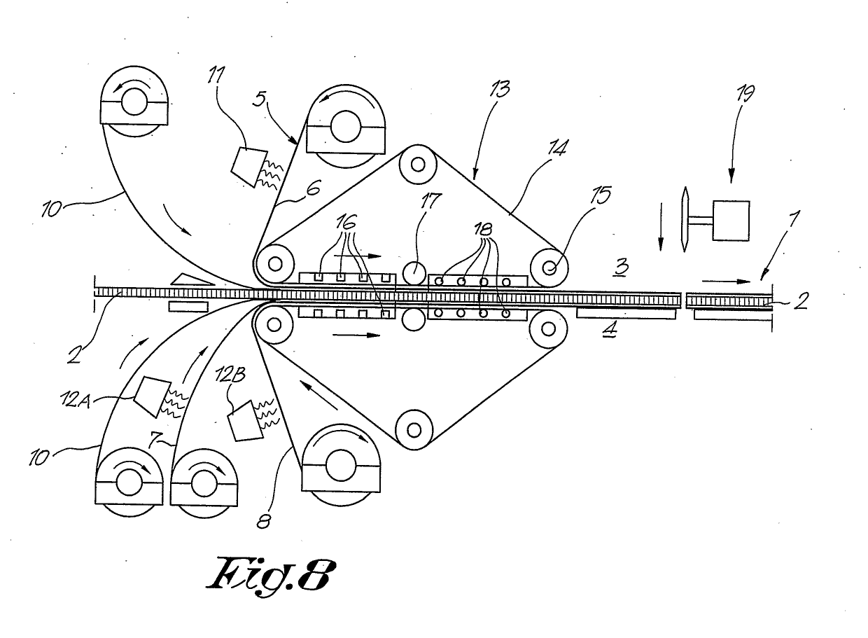

FIG. 6 represents two series of wires 7 directed diagonally to each other, whereby the wires 7 are connected to each other either or not in a few or in several intersections, such that a net is formed. It is clear that the wires 7 can also be woven.

Such intersecting wires, either or not in the shape of a net or a tissue, are capable of absorbing tensions in both directions of the wires 7 and also in all intermediate directions.

According to a special embodiment, as represented in FIG. 7, the wires 7 of a single series of wires 7 can be put closer together locally, such that a larger resistance against tensile stress and deformations of the panel is obtained where the wires 7 have a higher density, immediately following the lamination.

Wires and especially a wire net, as described in FIG. 7, will not only have a larger resistance against tensile stress, but also a certain resistance against compression stress if the rigidity of the wire is sufficiently large, such as for example in case of a closely linked steel wire net with wires having a diameter of 1 mm. Also this resistance against compressive stress helps to keep the panel flat and to offer resistance to the internal tensions in the enamelled steel, as soon as the panel leaves the laminator in an entirely flat state.

It is clear that also the wires 7 of both series of wires 7 can be provided closer together locally, and that the wires 7 can also follow other patterns, possibly specifically adjusted to the expected tensions.

The wires 7 can also be provided on the visual side, more particularly between the enamelled metal plate 5 and the support 2, or on both sides of the support 2.

The support 2 can be made of numerous materials, whereby said support 2 can preferably be made in a continuous manner.

Other possible materials for supports 2 are for example chipboard, corrugated board, honeycomb structures made of cardboard, polyurethane foam, polystyrene supports, plastic supports and the like.

In many cases, an adhesive layer will be required between the support 2 and the wires 7 or over the wires 7 and against the support 2, more particularly between the wires 7 and the back coating 8 or between the wires 7 and the enamelled metal plate 5 respectively, depending on whether the wires 7 are provided on the back side 4 or on the visual side 3 of the visual communication panel 1.

Such an adhesive layer can for example be based on polyethylene acrylic acids, and is preferably provided as an adhesive film or as a layer of glue in the course of a continuous production process. Gluing is done in this case under the influence of pressure and temperature.

The back coating 8 may for example also consist of aluminium foil, either or not provided with a paper layer, or of a synthetic foil or of a fibre-reinforced protective foil.

The wires 7 can just as well be made of other metals or alloys, or of glass fibres or carbon fibres.

The wires are preferably made of a material 25 with a large modulus of elasticity and with a large yield point.

The wires 7 may also have a non-round section, for example a flat section, an oval, a square or a polygonal section.

The perimeter of the cross section may be even or it may be toothed.

The diameter of the largest measurable distance between two opposite sides of a cross section of the wires is preferably situated between 0.01 mm and 5 mm.

Finally, it should be noted that the wires 7 can be coated.

FIG. 8 schematically represents a device which can be used with the method according to the invention.

The support 2, which is made in this case of a filled polypropylene synthetic foil formed into a thermoplastic honeycomb structure, as described in Belgian patent application No. 2003/0263, is continuously supplied, and on the visual side 3 is initially provided an adhesive film 10 in a continuous manner which is based for example on polyethylene acrylic acids, and immediately thereafter the enamelled metal plate 5 is provided, which has been heated just before by an infrared heating device 11.

At the same time, an adhesive film 10 is provided in a continuous manner against the back side 4 of the support 2, as well as the wires 7 which are somewhat pre-heated by an infrared heating device 12a and subsequently the back coating 8, whereby the latter is made of polypropylene foil which is heated just before its application by a second infrared heating device 12b.

The whole of provided layers and the support 2 are subsequently guided through a laminating device 13 which in this case consists of two endless belts 14 provided opposite each other which are each guided around three rollers 15 and in which are provided heating elements 16, press-on rollers 17, for example calender rollers and cooling elements 18.

Under the influence of pressure and temperature, exerted by the laminating device 13, the adhesive films 10 will be activated, and a bond is created between the different components of the panel.

After the laminating device 13, the visual communication panels 1 are cut to size by the cut or chop device 19.

It is clear that pressure can be exerted by means of the described calender rollers as well as by means of a laminating device.

The wires 7 or wire nets can also be strongly pre-heated, for example by means of an infrared heating device, such that the wires 7 or wire nets melt in the support. 2 without any adhesive film 10 having to be provided on that side.

It is also clear that the wires 7 or the wire nets can possibly be first provided against the support 2, and that an adhesive film 10 is provided over the applied wires 7 which then adheres to the support 2 between the wires 7 or through the meshes of a provided net of wires.

The back coating 8 is not required, but it can protect the wires 7, for example against rust, and it can also embellish the appearance.

The present invention is by no means limited to the above-described embodiments given as an example and represented in the accompanying drawings; on the contrary, such a method and device for manufacturing visual communication panels can be made according to different variants while still remaining within the scope of the invention.

1. Visual communication panel having a visual side and a back side, comprising a support, onto which is provided at least on the visual side an enamelled metal, said support having on at least one of said sides wires arranged to prevent deformations.

2. Visual communication panel according to claim 1, wherein the wires are directed mainly parallel.

3. Visual communication panel according to claim 1, wherein the wires are oriented according to two diagonal directions.

4. Visual communication panel according to claim 1, wherein the wires form a net or a tissue.

5. Visual communication panel according to claim 1, wherein the wires are provided with teeth.

6. Visual communication panel according to claim 1, wherein the distance between the wires may be locally different.

7. Visual communication panel according to claim 1, said panel having side edges, wherein near at least one of the side edges of the panel, the wires are situated closer together in at least one direction.

8. Visual communication panel according to claim 1, wherein the wires are steel wires.

9. Visual communication panel according to claim 1, wherein the wires have a round cross section.

10. Visual communication panel according to claim 1, wherein the wires have a non-round cross sections for example a flat, oval, square or polygonal section.

11. Visual communication panel according to claim 1, wherein the wires are coated.

12. Visual communication panel according to claim 1, wherein the wires contain glass fibres.

13. Visual communication panel according to claim 1, wherein the wires contain carbon fibres.

14. Visual communication panel according to claim 1, wherein the wires are mainly made of a metal or an alloy.

15. Visual communication panel according to claim 1, wherein the wires have a cross section with a diameter between 0.01 mm and 5 mm.

16. Visual communication panel according to claim 1, wherein between the wires and the support there is provided an adhesive layer.

17. Visual communication panel according to claim 1, wherein an adhesive layer is provided on the wires.

18. Visual communication panel according to claim 16, wherein the adhesive layer contains polyethylene acrylic acids.

19. Visual communication panel according to claim 1, wherein the wires are provided on the back side of the visual communication panel, and in that a back coating is provided on the wires.

20. Visual communication panel according to claim 19, wherein the back coating comprises aluminium foil, either or not provided with a paper layer, or of a synthetic foil or of a fibre-reinforced protective foil.

21. Method for manufacturing a visual communication panel comprising: providing a support with a coating of enamelled metal on at least one side, and wherein the support is provided with wires or wire nets on at least one side.

22. Method according to claim 21, wherein the wires or wire nets are provided in a continuous manner.
